(19) United States
(12) Patent Application Publication
(10) Pub. No.: US 2006/0258205 A1
(43) Pub. Date: Nov. 16, 2006

(54) Textile comprising a conductor line system and method for its production

(76) Inventors: Ivo Locher, Zug (CH); Gerhard Troester, Dubendorf (CH)

Correspondence Address: HOFFMAN WARNICK & D'ALESSANDRO, LLC, 75 STATE STREET, 14TH FLOOR, ALBANY, NY, 12207, US

(21) Appl. No.: 11/432,586

(22) Filed: May 11, 2006

(30) Foreign Application Priority Data
May 13, 2005 (EP) 05010476.9

(51) Int. Cl. H01R 33/945

(52) U.S. Cl. 439/517

(57) ABSTRACT

The invention relates to a textile comprising a conductor line system and a method for its production. The conductor line system has an arrangement of a plurality of electric conductor lines. At least one electric component is connected to specific electric conductor lines. In accordance with the invention an adapter element is arranged between the electric component and the conductor line system. On one side the adapter element has at least one connecting portion that is adapted to the arrangement of the electric conductor lines. On the other side the adapter element has at least one connecting portion that is adapted to a connecting arrangement of the electric component.

### FIELD OF THE INVENTION

The invention relates to a textile comprising a conductor line system which includes an arrangement of a plurality of electric conductor lines, and at least one electric component which is connected to specific electric conductor lines. The invention further relates to a method for producing a textile which is designed with a conductor line system having an arrangement of a plurality of electric conductor lines, with at least one electric component being connected to specific electric conductor lines.

### BACKGROUND OF THE INVENTION

There is a rapidly increasing demand for textiles that include a conductor line system. Today a large part of the population carries electronic devices such as mobile phones, PDA's or MP3-players etc. with them on a regular basis. Therefore efforts are made to an increasing extent to integrate such electric devices in textiles or to provide textiles with electric and electronic functions.

From DE-A-103 07 507 and US-A-2004/0259391 textiles are known for example in which single electric conductor lines are arranged. These electric conductor lines are connected to specific electric components that are fixed to the textile.

To this end the electric components have a connecting arrangement that is adapted to the arrangement of the conductor lines in the textile. However, the connection of the electric components can raise problems, especially if a connection has to be fixed to a conductor line system with a small mesh spacing and if electric components have to be fixed with a plurality of different connections. Moreover, apart from its electrical connection the electric component has to be fixed in a mechanically reliable manner to the textile. In doing so defects in the electric and/or mechanic connection of the electric component with the textile may occur repeatedly.

### SUMMARY OF THE INVENTION

The invention provides a textile and a method for its production by means of which electric components can be connected easily and at the same time reliably with the textile.

A first aspect of the invention provides a textile comprising a conductor line system, which includes an arrangement of a plurality of electric conductor lines, and at least one electric component which is connected to specific electric conductor lines, wherein: an adapter element is arranged between the electric component and the conductor line system; the adapter element has on one side at least one connecting portion that is adapted to the arrangement of the electric conductor lines; and the adapter element has on the other side at least one connecting portion that is adapted to a connecting arrangement of the electric component.

A second aspect of the invention provides a method for producing a textile, which includes a conductor line system having an arrangement of a plurality electric conductor lines, with at least one electric component being connected to specific electric conductor lines, wherein: an adapter element is provided between the electric component and the conductor line system, the adapter element has on one side at least one connecting portion that is adapted to the arrangement of the electric conductor lines and connected to the specific electric conductor lines, and the adapter element has on the other side at least one connecting portion that is adapted to a connecting arrangement of the electric component and connected thereto.

The textile according to the invention is characterized in that an adapter element is arranged between the electric component and the conductor line system, in that the adapter element has on one side at least one connecting portion that is adapted to the arrangement of the electric conductor lines and in that the adapter element has on the other side at least one connecting portion that is adapted to a connecting arrangement of the electric component.

A fundamental idea of the invention may be seen in the fact that the electric component is no longer fixed directly onto the textile. For the connection use is made of an interposed adapter element which is specifically adapted to the structure of the conductor line system of the textile on the one hand and to the connecting arrangement of the electric component on the other hand. As a result, it is no longer necessary to specifically adapt either the conductor line structure of the textile to the electric component that is to be fixed or to adapt the connecting arrangement of the electric component to the conductor line system. This permits a greater degree of freedom in the choice and design of the conductor line system in the textile and in the choice of the electric components. According to the invention it is therefore possible that different electric components, such as electronic parts, sensors, actuators, energy sources, switches etc. that have various kinds of connecting arrangements can be fixed without problem to a textile having a uniform conductor line structure.

Another advantage of the invention resides in the fact that the adapter element can be connected with a high solidity both with the textile and the electric component. In this way a secure and at the same time reliable electric and mechanical connection is achieved between the textile and the electric component.

In principle, the adapter element can be designed in an inflexible manner having any chosen thickness.

A preferred embodiment of the invention resides in the fact that the adapter element is designed as a thin, in particular as a flexible board. By preference, the board has a thickness ranging between 0.1 mm and 3 mm, with the connecting portions being electrically connected with each other on both sides of the board.

In accordance with the invention it is particularly preferred that the adapter element has a flexibility and/or elasticity that is smaller than that of the textile but greater than that of the electric component. Hence, the adapter element also serves to bring the greatly differing mechanical properties of the highly flexible textile into line with the usually inflexible electric component. Thus, during the use of the textile an undesired detachment of the inflexible electric component from the soft, deformable textile is prevented. The adapter element is preferably designed as a layer or a film of a suitable plastic, such as PE, PA, PU, PVC, FR-3, FR-4 etc.

For a particularly good connection provision is made such according to the invention that the adapter element is larger in its surface than a surface area of the electric component. This allows for a particularly good mechanical fixing of the adapter element on the textile. In addition, even in the case of an extremely narrow conductor line system having a spacing of conductor lines of less than 1 mm a reliable electric connection can be established through connecting portions which are spaced well apart from one another. This risk of an unintended electrical short circuit is practically avoided thereby.

Furthermore, the adapter element can be used to accommodate several electric components.

Basically, the electric conductor line system can be arranged in various ways on or in the textile. For instance the conductor line system can be imprinted or it can be produced through electrochemical treatment of the textile. The conductor line system can have any chosen arrangement, e.g. it can have parallel conductor lines only. However, according to the invention it is especially preferred that the conductor line system has a mesh-shaped or net-like arrangement of conductor lines that are woven into the textile. Such an arrangement interferes to a minimum degree with the normal use of the textile for example as a garment. In addition, by electrically connecting single intersecting conductor lines or by appropriately disconnecting single lines highly complex conductor line structures can be designed in the textile in a relatively simple manner. Preferably, the mesh or net spacing of the conductor lines that intersect in a substantially perpendicular fashion ranges between 0.2 mm and 20 mm.

Especially in the case of very tightly meshed conductor line arrangements provision is made according to the invention so that the connecting portion of the adapter element located on the side facing towards the conductor line system is designed for an arrangement extending at an angle to the conductor lines. For instance in the case of a square mesh structure having a mesh spacing D and an arrangement of the adapter element that is inclined by 45° to the conductor lines and has linearly arranged connecting portions a spacing can be attained between the individual connecting points that is increased approximately by the factor 1.4. Particularly in the case of very small electronic components and an extremely fine mesh structure this proves to be of advantage for a reliable electric connection free of short circuits. Moreover, by such an arrangement cuts in the textile for line disconnection can be avoided. As a result, the strength and stability of the textile is increased.

In accordance with the invention a facilitated production results from the fact that at least on one side the adapter element is provided with an adhesive. The adhesive can be a glue or a plastic layer which, by being subjected to the appropriate thermal, chemical or mechanical treatment, makes a solid, stable connection with the basic fabric of the textile or the electric component. If an adhesive is used on both sides of the adapter element, the adhesives concerned can be different electrically insulating means corresponding to the textile or the electric component. On the connecting portions an electrically conductive adhesive can be applied accordingly.

Furthermore, according to the invention an adapter element is provided which is characterized in that at least one connecting portion is provided on one side which is adapted to an arrangement of electric conductor lines of a conductor line system of a textile and in that at least one connecting portion is provided on the other side which is adapted to a connecting arrangement of an electric component. As a thin layer of film that is easy to produce this adapter element can be produced in a cost-effective manner in a great variety. In this manner electric components with greatly differing connecting arrangements can be fixed to a textile with a uniform conductor line system. The adaptation of the first connecting portions is effected such that they lie on prepared points of intersection of the conductor line system.

The method according to the invention for producing a textile is characterized in that an adapter element is provided between the electric component and the conductor line system, in that the adapter element has on one side at least two connecting portions that are adapted to the arrangement of the electric conductor lines and connected to the specific electric conductor lines, and in that the adapter element has on the other side at least one connecting portion that is adapted to a connecting arrangement of the electric component and connected thereto.

By this method the above-described textile can be provided in a simple, reliable and at the same time particularly variable manner with a plurality of different electric components having various connecting arrangements.

By preference, the conductor lines are woven into the textile as electrically conductive threads having an external insulation and a desired line structure is formed by electrically connecting and/or disconnecting specific conductive threads. As a result, the conductor line system can be produced in a reliable manner as early as during the weaving of the textile. The electrical connection of the externally insulated conductive threads is carried out by removing the external insulation, for example by means of a laser or through etching and a subsequent application of an electric connecting means, such as an electrically conductive adhesive. The defined disconnection of electrically conductive threads in order to prevent an undesired short circuit can equally be carried out by means of a laser, through etching or a mechanical cutting process.

### BRIEF DESCRIPTION OF THE DRAWINGS

In the following the invention will be described further by way of embodiments that are schematically illustrated in the drawings, wherein:

FIG. 1 shows the fixing of an electric component to a textile.

FIG. 2 shows a connecting arrangement of two electric components located on a conductor line system.

FIG. 3 shows various connecting arrangements on a conductor line system in order to illustrate connecting problems.

FIG. 4 shows the application of an electric component according to the invention.

FIG. 5 shows a schematic connecting arrangement of an adapter element according to the invention located on a textile.

FIG. 6 shows a textile according to the invention with two electric components fixed thereto.

FIG. 7 shows a connecting arrangement at an angle in accordance with the invention.

FIG. 8 shows two examples of connecting arrangements located on an adapter element according to the invention.

### DETAILED DESCRIPTION OF THE INVENTION

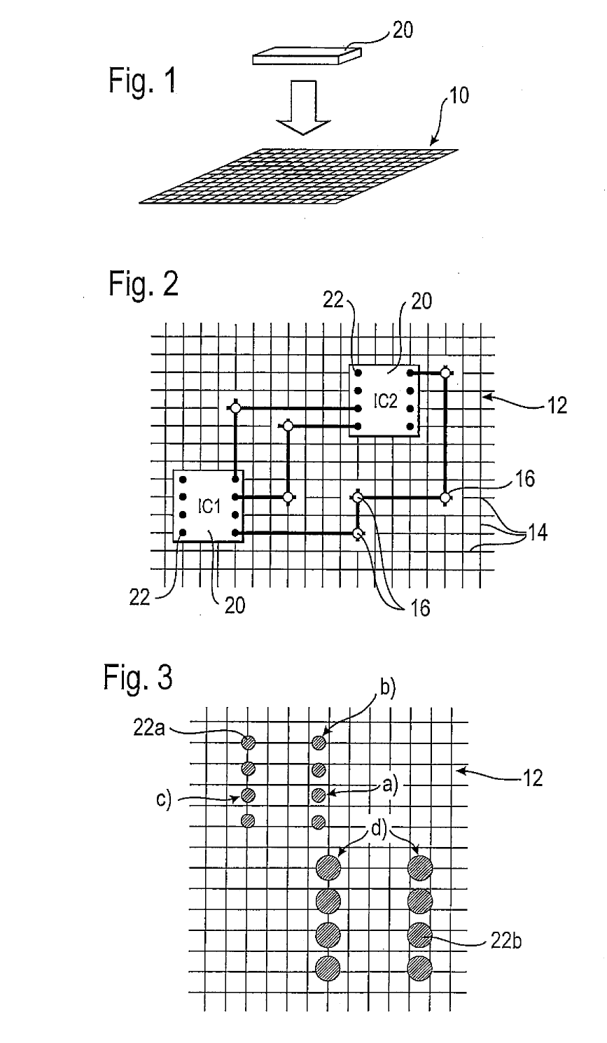

In FIG. 1 a starkly schematized textile 10 according to the invention is shown to which an electric component 20 is applied. The textile 10 consists of a basic textile made of non-conductive thread materials, more particularly a non-conductive basic fabric comprising monofilament and/or multifilament threads. Into this basic fabric a conductor line system consisting of electrically conductive threads is woven. The electric component can be constituted by an electronic part, a sensor, an electric actuator, but also e.g. a mechanical switching element such as a switch or a key button.

In FIG. 2 the basic arrangement of two electrical components 20 on a conductor line system 12 is shown which is provided in a mesh-shaped or net-like manner in the textile 10. The conductor line system 12 consists of a plurality of evenly arranged intersecting electric conductor lines 14. These are conductive metal wires, more particularly copper and/or silver wires or threads of electrically conductive plastic having an external insulation. To produce a desired conductor line the external insulation of intersecting conductor lines 14 is removed in an area of narrow limits at defined connecting points 16 and an electrically conductive connection is established by means of an electric connecting means.

The single electric components 20 have a connecting arrangement 22 comprising several points of contact that have to be connected electrically to defined conductor lines 14. To this end the external insulation of the specific electric conductor lines 14 is removed at certain points, preferably at the points of intersection, as already set out above. By means of an electrically conductive plastic or solder these points of contact are connected in an electrically conductive manner with the connecting points of the connecting arrangement 22.

When connecting the electric component 20 to the conductor line system 12 various problems may arise which will be explained in conjunction with FIG. 3. If the connecting arrangement 22 is not adapted precisely to the arrangement of the conductor line system 12 or if the electric component 20 is not adjusted precisely this may lead to a faulty contact, as illustrated in a). In this case the establishment of an electrically conductive connection with a desired conductor line 14 failed. Furthermore, the connecting arrangement 22a can be applied onto the textile 10 in a displaced manner such that it does not lie precisely on a point of intersection desired but only on a weft conductor line, as in b), or only on an warp conductor line, as in c). This may also lead to faulty contacts.

If the single points of contact are larger than a grid spacing of a mesh-shaped conductor line system 12, as shown in d), several conductor lines may be connected in an undesired way. Likewise, this may lead to faulty contacts and therefore malfunctions of the electric component 20.

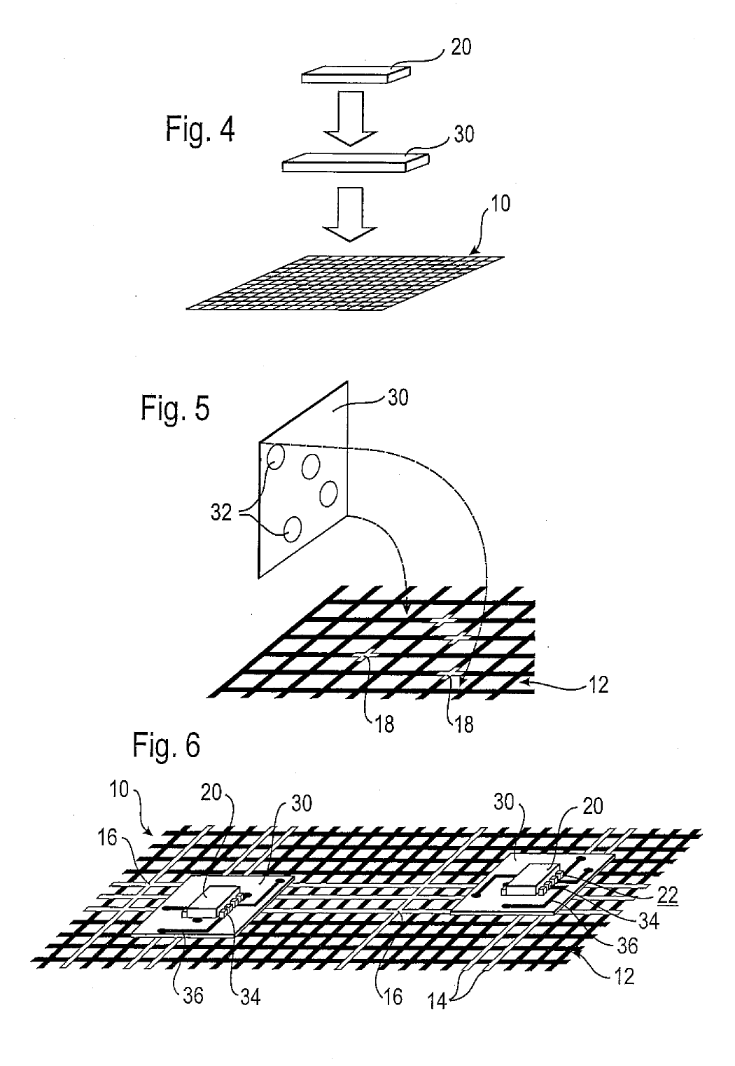

To avoid these problems an adapter element 30 is arranged according to the invention between the textile 10 with the conductor line system 12 and the electric component 20, as is schematically shown in FIG. 4.

For this purpose the adapter element 30 according to the invention has first connecting portions 32 on the side facing towards the textile 10, which are arranged according to the grid of the mesh-shaped conductor line system 12. Corresponding to the first connecting portions 32 on the one side of the adapter element 30 connecting points 18 are prepared in the conductor line system 12 which have been produced in the manner described before by removing the external insulation of the electric conductor lines 14. The fixing of the board-shaped or film-like adapter element 30 is carried out by means of an adhesive that makes a solid mechanical connection with the basic fabric of the textile. In the portions of the connecting points 18 an electrically conductive adhesive is provided which allows for a selective electrical connection between the connecting points 18 of the conductor line system 12 with the first connecting portions 32 of the adapter element 30.

In this way electric components 20 having the most varying connecting arrangements 22 can be applied in a reliable manner to textiles with any chosen conductor line system 12, as shown for example in FIG. 6. The electric components 20 shown here include a connecting arrangement 22 having four closely located connections on each longitudinal side. These connections of the connecting arrangement 22 of the electric component 20 correspond to second connecting portions 34 arranged on the side of the adapter element 30 that faces away from the textile 10. From the individual second connecting portions 34 lines 36 disposed on the upper side lead to the desired end points on the adapter element 30. The end points of the lines 36 correspond in their location to the first connecting portions 32 on the underside of the adapter element 30. An electrical connection is achieved through a conductor which runs from the upper side through the thin wall thickness of the adapter element 30 up to the respective connecting portion 32 located on the underside of the adapter element 30. Alternatively, the distributing lines can also be guided along the underside of the adapter element 30.

As can be seen quite well in FIG. 6, a very closely disposed connecting arrangement 22 of the electric component 20 can therefore be straightened spatially and adapted to a given conductor line system 12. With regard to its surface dimensions the adapter element 30 can amount to several times that of the surface area of the electric component 20, whereby a good mechanical fixing of the electric component on the textile 10 is also achieved. In addition, a surrounding edge portion of the adapter element 30 protects and insulates the electric connecting points disposed inside.

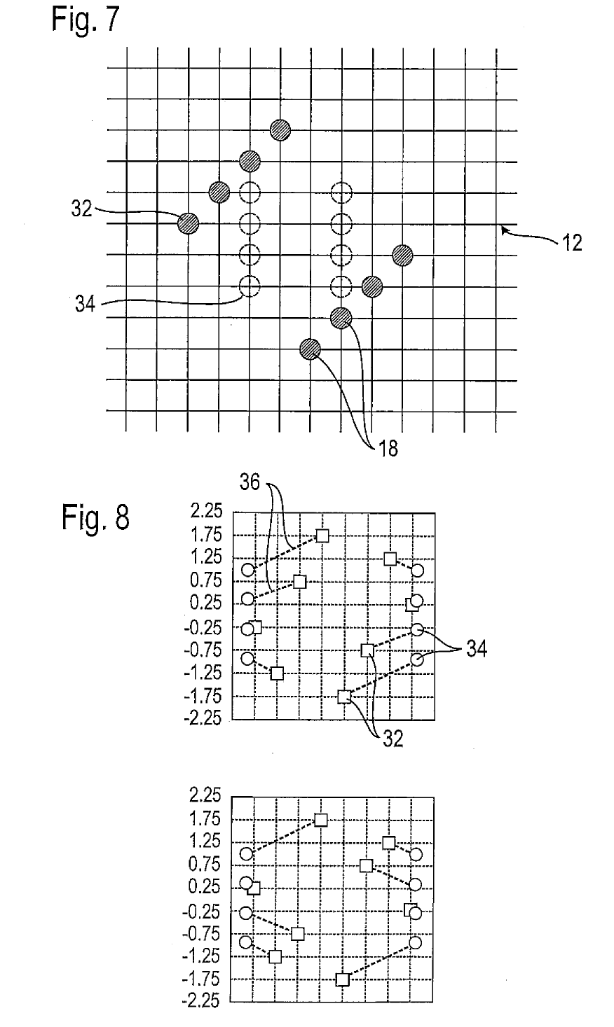

According to the preferred embodiment of FIG. 7 the first connecting portions 32 of the adapter element 30 can be arranged in an offset manner to an orthogonal, mesh-shaped conductor line system 12. Through this offset arrangement the achievement is made in that the connecting points 18 do not lie on the same conductor lines 14. As a result, a disconnecting of the conductor lines that would otherwise be necessary can be avoided so that the risk of a faulty contact and a short circuit is reduced further and the stability is increased. The second connecting portions 34 located on the upper side of the adapter element 30 are shown schematically by a dotted line.

As a result of the invention a spatial straightening is achieved between the first connecting portions 32, which serve for the connection with the conductor line system 12, and the second connecting portions 34, which are arranged on the upper side of the adapter element 30 and serve for the electrical connection with a connecting arrangement 22 of an electric component 20. Between the individual square points of contact of the first connecting portions 32 located on the underside of the adapter element 30 and the second circular connecting portions 34 located on the upper side of the adapter element 30 junction lines 36 are provided which are illustrated by dotted lines 36.

Two examples of connecting arrangements located on an adapter element according to the invention are illustrated in FIG. 8.

The foregoing description of the preferred embodiments of this invention has been presented for purposes of illustration and description. It is not intended to be exhaustive or to limit the invention to the precise form disclosed, and obviously, many modifications and variations are possible.

1. Textile comprising a conductor line system, which includes an arrangement of a plurality of electric conductor lines, and at least one electric component which is connected to specific electric conductor lines, wherein:
an adapter element is arranged between the electric component and the conductor line system;
the adapter element has on one side at least one connecting portion that is adapted to the arrangement of the electric conductor lines; and
the adapter element has on the other side at least one connecting portion that is adapted to a connecting arrangement of the electric component.

2. Textile according to claim 1,
wherein the adapter element comprises a thin flexible board.

3. Textile according to claim 1,
wherein at least one of a flexibility and elastisity of the adapter element is smaller than that of the textile but greater than that of the electric component.

4. Textile according to claim 1,
wherein the adapter element is larger in its surface area than a surface area of the electric component.

5. Textile according to claim 1,
wherein the conductor line system has a mesh-shaped or net-like arrangement of conductor lines that are woven into the textile.

6. Textile according to claim 1,
wherein the connecting portion of the adapter element located on the side facing towards the conductor line system is designed for an arrangement extending at an angle to the conductor lines.

7. Textile according to claim 1,
wherein at least on one side the adapter element is provided with an adhesive.

8. Textile according to claim 1,
wherein the adapter element has on one side at least one connecting portion with at least two connecting points which are adapted to a mesh-shaped arrangement of the electric conductor lines, and the connecting points are arranged in an offset manner with respect to the mesh-shaped arrangement of the conductor line system such that the connecting points do not lie on the same conductor lines.

9. Adapter element for a textile according to claim 1,
wherein at least one connecting portion is provided on one side of the adapter element that is adapted to an arrangement of electric conductor lines of a conductor line system of the textile, and at least one connecting portion is provided on the other side of the adapter element that is adapted to a connecting arrangement of an electric component to be fixed.

10. Method for producing a textile, which includes a conductor line system having an arrangement of a plurality electric conductor lines, with at least one electric component being connected to specific electric conductor lines, wherein:
an adapter element is provided between the electric component and the conductor line system,
the adapter element has on one side at least one connecting portion that is adapted to the arrangement of the electric conductor lines and connected to the specific electric conductor lines, and
the adapter element has on the other side at least one connecting portion that is adapted to a connecting arrangement of the electric component and connected thereto.

11. Method according to claim 10,
wherein the conductor lines are woven into the textile as electrically conductive threads having an external insulation and a desired line structure is formed by at least one of electrically connecting and disconnecting specific conductive threads.
